(19) United States
(12) Patent Application Publication
(10) Pub. No.: US 2023/0017655 A1
(43) Pub. Date: Jan. 19, 2023

(54) ULTRAVIOLET CURABLE EPOXY DIELECTRIC INK

(71) Applicants: Raytheon Company, Waltham, MA (US); The University of Massachusetts, Lowell, MA (US)

(72) Inventors: Yuri Piro, Boston, MA (US); Christopher R. Areias, Lawrence, MA (US); Andrew M. Luce, Marlborough, MA (US); Oshadha Ranasingha, Salem, NH (US); Emily Lamport, Pelham, NH (US); Alkim Akyurtlu, Arlington, MA (US); Edward D. Kingsley, Stow, MA (US); Craig A. Armiento, Acton, MA (US)

(21) Appl. No.: 17/372,907

(22) Filed: Jul. 12, 2021

(51) Int. Cl. C09D 11/38; C09D 11/328; C09D 11/101; C09D 11/102; C09D 11/037; B41M 5/00; B41J 11/00

(52) U.S. Cl. CPC C09D 11/38; C09D 11/328; C09D 11/101; C09D 11/102; C09D 11/037; B41M 5/0023; B41J 11/00214

(57) ABSTRACT

A dielectric ink composition includes an epoxy precursor and a photoacid generator. The dielectric ink composition is aerosolable and ultraviolet (UV) curable.

### BACKGROUND

The present disclosure generally relates to dielectric inks, and more specifically to ultraviolet (UV) curable epoxy dielectric inks and methods of methods of manufacturing and methods of using thereof

UV-curable dielectric inks are used in a variety of applications, for example, to protect and insulate electrical components in printed electronics, such as printed circuit boards. These inks can also be used to make multilayer circuits in which conductive ink layers are printed below, above, and/or below and above the printed dielectric ink layers. As arranged in this way, the printed electronic component possesses reliable crossover circuitry. UV-curable inks can also be printed in other products and on surfaces such as glass and have been used in security printing, among others. Dielectric coatings also can be applied by printing onto flexible substrates, including over, under, and in between printed conductive inks that, to serve as crossover dielectrics that enable the formation of multilayer circuitry, and/or as protective flexible dielectric coatings over the silver conductive tracks before the circuits enter the component assembly process.

### SUMMARY

According to one or more embodiments, a dielectric ink composition includes an epoxy precursor and a photoacid generator. The dielectric ink composition is aerosolable and ultraviolet (UV) curable.

According to other embodiments, a method of printing a dielectric ink includes combining an epoxy precursor and a photoacid generator to form a pre-polymer composition. The method further includes atomizing the pre-polymer composition into an aerosol jet stream. The method also includes depositing the aerosol jet stream onto a substrate to form a layer of dielectric ink and curing the layer of dielectric ink using ultraviolet (UV) light.

Still yet, according to other embodiments, a method of making a dielectric ink includes combining an epoxy precursor with a photoacid generator to form an aerosolable pre-polymer composition and curing the pre-polymer composition using ultraviolet (UV) light.

Additional features and advantages are realized through the techniques of the present disclosure. Other embodiments and aspects of the disclosure are described in detail herein and are considered a part of the claimed disclosure. For a better understanding of the disclosure with the advantages and the features, refer to the description and to the drawings.

### BRIEF DESCRIPTION OF THE SEVERAL VIEWS OF THE DRAWINGS

For a more complete understanding of this disclosure, reference is now made to the following brief description, taken in connection with the accompanying drawings and detailed description, wherein like reference numerals represent like parts:

FIG. 1 is a schematic diagram showing a side view of a layer of dielectric ink on a substrate;

FIG. 2 is schematic diagram of a dielectric ink being aerosol jet printed on a substrate;

FIG. 3 is a schematic diagram of multiple layers of a dielectric ink printed on a substrate;

FIG. 4A is an image of a dielectric ink printed on a substrate;

FIG. 4B is an image of a comparative dielectric ink printed on a substrate;

FIG. 5 is a graph of comparing thickness (micrometers) and surface roughness (micrometers) of dielectric inks;

FIG. 6 is a schematic diagram showing a cross-sectional side view of multiple layers of the dielectric ink printed to form a three-dimensional (3D) structure;

FIG. 7A is an image of a three-dimensional (3D) structure formed from a dielectric ink;

FIG. 7B is an enlarged image of a portion of the three-dimensional (3D) structure of FIG. 7A;

FIG. 8 shows a diagram of how the ASTM adhesion tape test results are assessed;

FIG. 9 shows the results of testing silver ink prior to the adhesion tape test;

FIG. 10 shows the results testing silver ink after adhesion tape testing to Kapton;

FIG. 11 shows the results of testing silver ink after adhesion tape testing to metal;

FIG. 12 shows the results of testing silver ink after adhesion tape testing to glass; and

FIG. 13 shows the results of electrical characterization of various combinations of layers of silver ink with dielectric ink.

### DETAILED DESCRIPTION

Current formulations of UV-curable dielectric inks used for screen printers or syringe dispensers have high viscosities, which are challenging to print, result in thicker printed layers, and are not printable by aerosol jetting (aerosolable), which provides more controllable and thinner ink layers. Another drawback of current UV-curable dielectric ink formulations is that they have high loss tangencies and therefore challenging to use in printed microwave devices. Loss tangencies, which account for signal loss, is due to the dielectric (not conductor loss) and is thus an industry standard for comparing dielectrics of all types, including conventional planar laminates or additive/printed materials, including printed dielectric inks.

The UV-curable dielectric ink compositions, printed articles, including 3D articles and structure, and methods of manufacturing and using thereof disclosed herein address the challenges described above. The disclosed UV-curable dielectric ink compositions are formulated from low viscosity polymer precursors, photoacid generators, and in some embodiments, surface activating molecules and organic dyes, which result in a low viscosity dielectric ink composition that can be aerosol jet printed, as well as high print resolution and thinner and more controllable layers. The UV-curable dielectric ink compositions are aerosolable, UV-curable, have low microwave losses, which allows them to be used in microwave devices, and are non-toxic.

Once cured, dielectric ink is a polymeric epoxy ink. The dielectric ink composition used to manufacture for the polymeric dielectric ink includes at least one epoxy precursor, at least one photoacid generator, and optionally, in some embodiments, at least one photosensitizer, at least one organic dye, and at least one surfactant. The dielectric ink composition is aerosolable and UV-curable.

The at least one epoxy precursor includes an epoxy precursor monomer, epoxy precursor oligomer, or a combination thereof. Non-limiting examples of epoxy precursors include trimethylol propane triglycidal ether (Millipore Sigma), tris(4-hydroxyphenyl)methane triglycidyl ether (Millipore Sigma), poly(4,4′-isopropyledenediphenol-epichlorohydrin), cycloaliphatic epoxies (e.g., 3,4 epoxycyclohexylmethyl-3′,4′-epoxycyclohexane carboxylate), a mixture of poly(4,4′-isopropyledenediphenol-epichlorohydrin) and trimethylol propane triacrylate (Hexion), or any combination thereof. According to one or more embodiments, the at least one epoxy precursor includes a monomeric, oligomeric ether, or a polymeric ether. According to some embodiments, the at least one epoxy precursor includes an epichlorohydrin monomer, epichlorohydrin oligomer, or epichlorohydrin polymer.

In one or more embodiments, the at least one epoxy precursor is present in the dielectric ink composition used to manufacture the polymeric dielectric ink in an amount of about 60 to about 95 weight % (wt. %). In some embodiments, the at least one epoxy precursor is present in the dielectric ink composition used to manufacture the polymeric dielectric ink in an amount of about 75 wt. % to about 95 wt. %. In other embodiments, the at least one epoxy precursor is present in the dielectric ink composition used to manufacture the polymeric dielectric ink in an amount of about 80 wt. % to about 87 wt. %.

The at least one photoacid generator is a non-toxic molecule that becomes more acidic, e.g., by photodissociation to produce a strong Lewis acid or dissociation of a proton, upon absorption of light. Photoacid generators are used for cationic polymerization, which is a slower and therefore easier to control polymerization technique compared to other types of polymerization used in photopolymers, such as free radical polymerization. Slowing down the cure rate with a photoacid generator provides significant control over the curing process kinetics. The photoacid generator absorbs light at wavelengths that generally vary and depend on the target application. In some embodiments, the photoacid generator absorbs ultraviolet light (UV) in a wavelength range of about 190 to about 365 nanometers (nm). In other embodiments, the photoacid generator absorbs UV light in a wavelength range of about 350 to about 400 nm. Yet, in other embodiments, the photoacid generator absorbs light at about 365 nm. A non-limiting example of a photoacid generator includes a triarylsulfonium hexafluorophosphate salt. In one or more embodiments, the photoacid generator is triarylsulfomium hexafluorophosphate salts in propylene carbonate (50-50 mix by weight) (Millipore Sigma). In other embodiments, the photoacid generator is a 50/50 wt. % mixture of diaryliodonium hexafluorophosphate and gamma butyrolactone. In embodiments, the photoacid generators are free of antimony.

In one or more embodiments, the at least one photoacid generator is present in the dielectric ink composition used to manufacture the polymeric dielectric ink in an amount of about 2 to about 25 weight % (wt. %). In some embodiments, the at least one photoacid generator is present in the dielectric ink composition used to manufacture the polymeric dielectric ink in an amount of about 4 wt. % to about 21 wt. %. In other embodiments, the at least photoacid generator is present in the dielectric ink composition used to manufacture the polymeric dielectric ink in an amount of about 4 wt. % to about 8 wt. %.

Optionally, the dielectric ink composition used to manufacture the polymeric dielectric ink includes one or more photosensitizers, one or more organic dyes, and one or more surfactants. The one or more photosensitizers is an organic molecule that absorbs and transfers the energy to another molecule. A non-limiting example of an organic photoacid generator includes isopropyl-9H-thioxanthen-9-one (Millipore Sigma).

In one or more embodiments, the at least photosensitizer is present in the dielectric ink composition used to manufacture the polymeric dielectric ink in an amount of about 0.01 to about 8 weight % (wt. %). In some embodiments, the at least one photosensitizer is present in the dielectric ink composition used to manufacture the polymeric dielectric ink in an amount of about 0.01 wt. % to about 5 wt. %. In other embodiments, the at least photosensitizer is present in the dielectric ink composition used to manufacture the polymeric dielectric ink in an amount of about 0.01 wt. % to about 2 wt. %.

The one or more optional organic dyes is an organic molecule that absorbs visible light (about 380 to about 750 nm) and bonds to another molecule. A non-limiting example of an organic dye includes 1-([4-(xylylazo)xylyl]azo)-2-naphthol (Millipore Sigma).

In one or more embodiments, the at least one optional organic dye is present in the dielectric ink composition used to manufacture the polymeric dielectric ink in an amount of about 0.01 to about 4 weight % (wt. %). In some embodiments, the at least one photosensitizer is present in the dielectric ink composition used to manufacture the polymeric dielectric ink in an amount of about 0.01 wt. % to about 2 wt. %. In other embodiments, the at least one organic dye is present in the dielectric ink composition used to manufacture the polymeric dielectric ink in an amount of about 0.01 wt. % to about 0.2 wt. %.

In some embodiments, the dielectric ink composition includes an organic dye that changes color when UV cured. For example, the dielectric ink composition includes be tris(4-hydroxyphenyl)methane triglycidyl ether (Millipore Sigma), which turns red upon UV curing, in some embodiments, which indicates when curing is complete. Without being bound by theory, the color change is caused by the interaction between the triphenyl methyl moiety on the tris(4-hydroxyphenyl)methane triglycidyl ether and the Lewis acid generated from the photoacid during UV exposure.

The one or more optional surfactants is a molecule that lowers the surface tension of the dielectric ink composition. The one or more optional surfactants is an anionic surfactant, a cationic surfactant, a nonionic surfactant, or a combination thereof. A non-limiting example of a surfactant includes TEGO Twin 4000 (Evonik).

In one or more embodiments, the at least surfactant is present in the dielectric ink composition used to manufacture the polymeric dielectric ink in an amount of about 0.01 to about 8 weight % (wt. %). In some embodiments, the at least one surfactant is present in the dielectric ink composition used to manufacture the polymeric dielectric ink in an amount of about 0.01 wt. % to about 5.0 wt. %. In other embodiments, the at least surfactant is present in the dielectric ink composition used to manufacture the polymeric dielectric ink in an amount of about 0.01 wt. % to about 3.0 wt. %.

The at least one epoxy precursor, at least one photoacid generator, and optionally, in some embodiments, at least one photosensitizer, at least one organic dye, and at least one surfactant are combined in appropriate amounts to form the dielectric ink composition. Upon exposure to UV light, the dielectric ink composition is cured to form the polymeric epoxy-based dielectric ink.

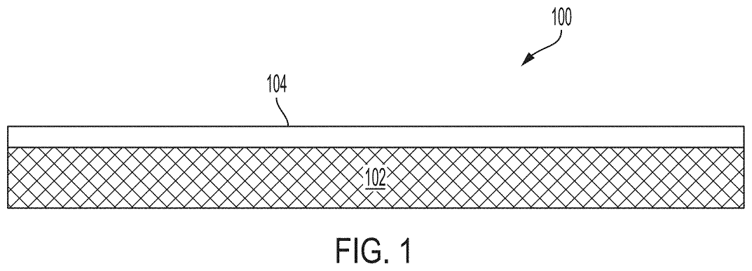

FIG. 1 is a schematic diagram showing a side view of an article 100 with a layer of dielectric ink 104 on a substrate 102. The substrate 102 can be any material, such as an electronic component or part, e.g., an RF or microwave device, component, or part. However, the substrate 102 is not intended to be limited and includes any type of material(s).

The dielectric ink composition has a low viscosity that enables it to be aerosol jet printed onto any substrate 102. According to one or more embodiments, the dielectric ink composition has a viscosity of about 50 to about 1000 centipoise (cP). According to some embodiments, the dielectric ink composition has a viscosity of about 100 to about 400 cP.

The dielectric ink also a dielectric constant of about 2.4 to about 4 in some embodiments. In other embodiments, the dielectric ink has a dielectric constant of about 2.8 to about 3.3.

A method of making a dielectric ink includes combining an epoxy precursor with a photoacid generator to form an aerosolable pre-polymer composition and curing, the pre-polymer composition using ultraviolet (UV) light.

A method of printing a dielectric ink includes combining an epoxy precursor and a photoacid generator to form a pre-polymer composition and atomizing the pre-polymer composition into an aerosol jet stream, followed by curing the pre-polymer composition in the aerosol jet stream using ultraviolet (UV) light and depositing the aerosol jet stream onto a substrate to form a layer of dielectric ink.

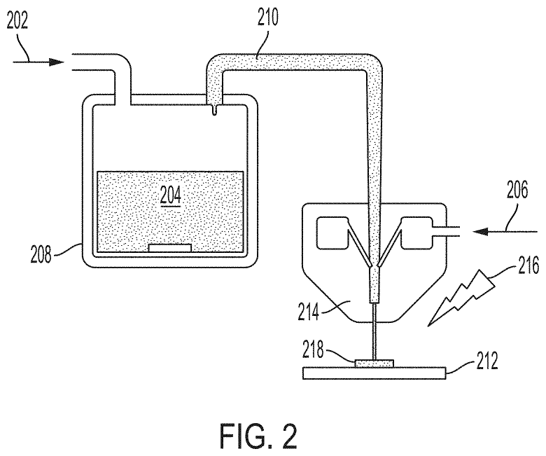

FIG. 2 is schematic diagram of a dielectric ink being printed on a substrate 212 according to embodiments. The liquid dielectric ink 204 is placed in a sample chamber 208, which is then atomized to produce tiny droplets 210, e.g., on the order of one to five micrometers in diameter. The atomized droplets (aerosol) are entrained in a gas stream 206 (e.g., nitrogen gas) and delivered to the print head 214. Here, an annular flow of clean gas is introduced around the aerosol stream to further focus the droplets into a tightly collimated beam of material. The combined gas streams exit the print head 214 through a converging nozzle that compresses the aerosol stream to a diameter as small as, for example, 10 micrometers (μm). The jet of droplets exits the print head 214 at high velocity (˜50 meters/second) to form a thin layer 218 on the substrate 212.

One or more UV-light sources are present within the printing assembly, e.g., above the print head 214 or above the substrate 212, such that UV light 216 is directed onto the atomized droplets 210 and curing occurs in-situ, during or directly after deposition. The UV light sources can be UV lamps or UV-LED lamps, for example. Curing occurs slowly, and final curing occurs once the layer 218 is formed on the substrate 212. Advantageously, curing speed can be controlled through varying UV intensity. While conventional UV curable inks cure almost instantaneously upon deposition, the inks described cure on a slower time scale, e.g., on a scale of about 100 milliseconds (ms) to 5 seconds (s), depending on UV intensity. According to one or more embodiments, methods of depositing the inks described herein include varying the UV intensity to adjust the ink curing time, e.g., using a higher intensity to decrease the curing time or using a lower intensity to increase the curing time.

The low viscosity of the dielectric ink composition allows the ink to be aerosol jet printed (in other words, the ink is aerosolable), which provides the advantage of forming thin, high resolution layers onto a variety of substrates. In one or more embodiments, the dielectric ink forms a layer as thin as about 5 micrometers (μm) to about 40 micrometers (μm) on the surface of a substrate. In other embodiments, the dielectric ink forms a layer having a thickness of about 100 nanometers (nm) to about 2 micrometers (m). In other embodiments, the dielectric ink forms a layer having a thickness that is greater than 2 micrometers. Although the inks form very thin layers, they are highly tailorable and form very thick layers, depending on the aerosol-jet nozzle width used.

Aerosol jet printing also enables the dielectric ink to be printed in very thin line widths. In some embodiments, aerosol ink jetting the dielectric ink forms a line width about 20 micrometers (m) to about 250 micrometers (m) in pitch. In other embodiments, aerosol ink jetting the dielectric ink forms a line width of about 20 micrometers (μm) to about 100 micrometers (m).

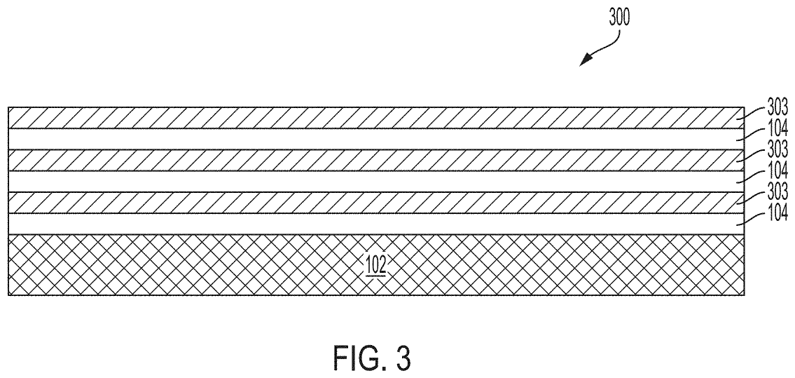

Due to the ability to form thin, controllable and reproducible layers, multilayer designs can be formed in some embodiments. Subsequent layers can provide layers of different thicknesses. FIG. 3 is a schematic diagram of multiple layers of a dielectric ink 104 printed on a substrate 102. The dielectric ink 104 layers are formed between layers of another material 303, for example, a conductive material.

According to one or more embodiments, the substrate 102 is a conductive material, e.g., a copper foil, and the conductive material 303 is a spiral coil. The dielectric ink 104 isolates the layers of spiral coil.

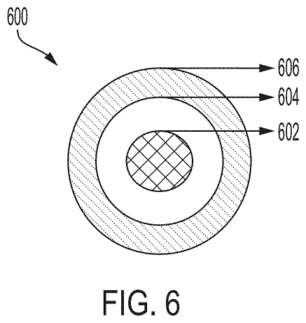

As the dielectric ink cures slowly, thin, overlapping layers that continue to flow together before finally curing, can be used to form three-dimensional (3D) articles using controllable two-dimensional layering, using aerosol jet printing in some embodiments. FIG. 6 is a schematic diagram showing a cross-sectional side view of multiple layers of the dielectric ink printed to form a 3D structure. In the schematic, 2D row printing is used to form a 3D article. The first row 602 has a 50% overlap, the second row 604 has 60% overlap, and the third row 606 has 70% overlap. Overlap refers to the percentage of the linewidth that a printed line overlaps the previous line. In general, when printing any shape (including 2D), the shapes are “rastered,” which means that the lines are printed back and forth to cover the area with some specified overlap. For example, if the linewidth is 50 micrometers (μm), 50% overlap means the lines are 25 micrometers (μm) apart.

In some embodiments, a 3D article is formed by forming two or more successive layers on the surface of a substrate, with each layer overlapping the previous layer by at least 50%. In other embodiments, the 3D article is formed by two or more successive layers on the surface of a substrate, with each layer overlapping the previous layer by less than 50%, and by using a higher UV cure intensity and/or an ink with higher photosensitivity, which results in a faster “set” of the ink upon deposition due to less lateral flow and more vertical build.

According to one or more embodiments, overlapping layers are printed with increasing overlap to produce steeper angle structures, and/or overlapping layers are printed with decreasing overlap to produce less steep angle structures.

Various parameters are adjusted to form the 3D structures, including layer overlap, UV cure intensity/ink photosensitivity, print speed, and aerosol flowrates. Sufficient overlap ensures that the layers build one upon the other, UV intensity/photosensitivity ensures vertical build over lateral flow, and the print speed and aerosol flowrates contribute to linewidth (control over which is necessary to guarantee the overlap % set in the print file).

The UV intensity will vary for systems with different UV sources, as well as with inks of different photo-sensitivities. According to one or more embodiments, a UV intensity of about 25% to about 100% is used. In other embodiments, a UV intensity of about 90% to about 100% is used.

The print speed will vary for systems with different UV sources as well as with inks of different photo-sensitivities. Generally, a faster or higher intensity cure is better because it allows use of faster print speeds and thus quicker prints. However, in some instances, the print speed is equipment dependent, as some systems are limited with respect to their mechanical stability when monitoring at high rates of spees. Further, at faster speeds, higher cure intensities may be required. In some embodiments, a print speed of about 0.5 millimeters per second (mm/s) to about 10 mm/s is used. In other embodiments, a print speed of about 4 mm/s to about 6 mm/s is used.

In other embodiments, an aerosol flow rate of about 700 standard cubic centimeters per minute (SCCM) to about 1500 SCCM is used. In some embodiments, an aerosol flow rate of about 1000 to about 1200 SCCM is used.

### EXAMPLES

### Example 1

Dielectric inks were prepared from the following formulations shown in Table 1.

TABLE 1
Dielectric ink formulations

| Ingredient | | | Ink Formulation (w %) | | | |
|---|---|---|---|---|---|---|
| Type | Name | Supplier | #362 | #303 | #356 | #360 |
| Oligomer- | Poly(4,4′Isopropyledenediphenol- | Hexion | 84.0 | 82.4 | | 81.5 |
| Monomer | Epichlorohydrin)/Trimethylol propane | | | | | |
| mixture | triacrylate | | | | | |
| Monomer | Trimethylol propane triglycidal ether | Millipore | | | 74 | |
| | | Sigma | | | | |
| Monomer | Tris(4-hydroxyphenyl)methane triglycidyl | Millipore | | | 10 | 2.0 |
| | ether | Sigma | | | | |
| Photoacid | Triarylsulfonium hexafluorophosphate | Millipore | 16.0 | 16.0 | 16.0 | 16.0 |
| | salts in propylene carbonate (50-50 mix by | Sigma | | | | |
| | weight) | | | | | |
| Photosensitizer | Isopropyl-9H-thioxanthen-9-one | Millipore | | 1.0 | | |
| | | Sigma | | | | |
| Organic Dye | 1-([4-(Xylylazo)xylyl]azo)-2-naphthol | Millipore | | 0.1 | | |
| | | Sigma | | | | |
| Surfactant | TEGO Twin 4000 | Evonik | | 0.5 | | 0.5 |

### Example 2

Dielectric inks were prepared by dispersing 2.0-25.0% photoacid, and in some instances 0.01%- 4.0% organic dye, 0.01% - 8.0% photosensitizer, and 0.01% - 8% surfactant, into 60.0%-95.0% epoxy monomer mixture in a 30mL glass jar covered in aluminum foil. The jar is placed on a stir table, and a Teflon coated stir bar was added to the vessel. The mixtures were stirred at 200 rpms for 4 hours.

### Example 3

The dielectric inks were aerosol jet printed using an OPTEMEC AEROSOL JET® 5X System. The following print parameters were used: tip size: 200 μm; print speed: 3 mm/s; linewidth: ˜50 μm; overlap: 50%; and pressures: 60 SCCM (sheath gas flow rate), 800 SCCM (atomizer flow rate), 0.479 PSI (exhaust pressure setpoint), 800 SCCM (virtual impactor flow rate), 80 SCCM (divert flow rate), 80 SCCM (boost flow rate). The sum of atomizer and virtual impactor sheath flowrates is termed the “push” and is the main source of propulsion of the aerosolized ink. The sheath collimates this flow into a narrow beam—higher sheath flow gives a tighter linewidth.

### Example 4

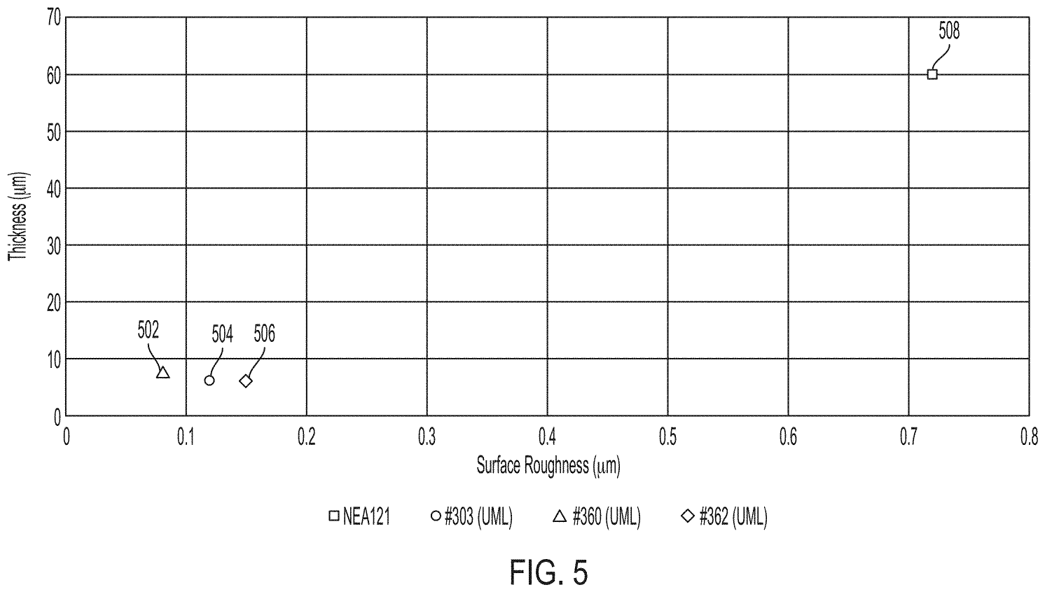

Dielectric inks (#303, #360, and #362) from Table 1 were compared to a commercially available dielectric ink (NEA121, an electrical adhesive that has been repurposed for aerosol jet printing and includes benzophenone initiator and a mercapto ester monomer) in terms of surface roughness and thickness. FIG. 5 is a graph of comparing thickness (micrometers) of the inks as a function of surface roughness (micrometers). Upon aerosol jet printing, the inventive dielectric inks 502, 504, 506 provided layers that were significantly thinner, e.g., thicknesses of about 6.1 to about 7.3 micrometers (μm), than the commercially available ink (NEA121) 508, with a thickness of about 60 micrometers (μm). The inventive dielectric inks 502, 504, 506 also had smoother surfaces, with surface roughnesses of about 0.08 to about 0.15 micrometers (μm), compared to about 0.72 for commercially available ink (NEA121) 508.

### Example 5

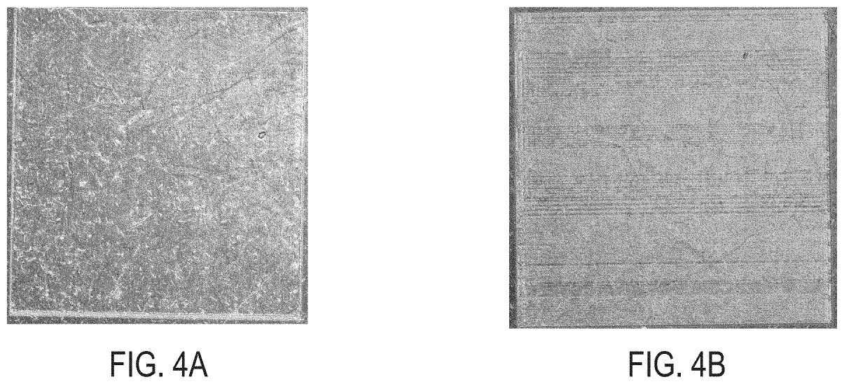

FIG. 4A is an image of an inventive UV-curable dielectric ink composition printed on a substrate. FIG. 4B is an image of a comparative dielectric ink (commercially available NEA121) printed on a substrate. As shown, the UV-curable dielectric ink (FIG. 4A) has a smoother surface, which is due to the slower curing that occurs. The ink can flow onto itself before finally curing, and the ink is therefore conformal to the surface of the substrate. The resulting heights in the x- and y-direction, respectively, are 14.3 micrometers and 10.3 micrometers, respectively. The commercially available ink (NEA121) (FIG. 4B) cures instantly, which does not allow for reflow of the ink to form a smooth surface, and in turn, results in a layer with a rough surface. The resulting heights in the x-and y-direction, respectively, are 20.1 micrometers and 21 micrometers, respectively.

### Example 6

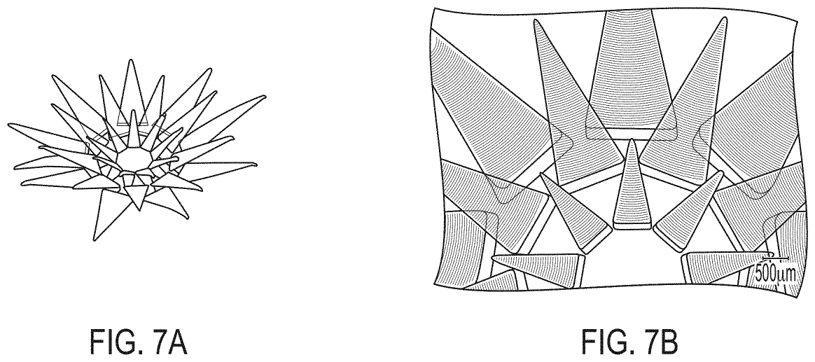

FIG. 7A is an image of a three-dimensional structure formed from a dielectric ink. FIG. 7B is an enlarged image of a portion of the three-dimensional (3D) structure of FIG. 7A. The article is a 3D flower with three rows of triangular, repeating petals. The 3D flower was 14 mm in diameter. Each row was printed with a different percentage of overlap and thus slant angle. The 3D flower was formed by printing three concentric rings of triangular petals using print parameters conducive to initiating UV “stacking,” which are shown in Table 2 below. Because the structure was printed from above, the outer rings were printed first to avoid interference with already printed structures. Additionally, as the rings move inward, each is printed with increased overlapping to produce steeper-angled pedals that extend above and do not interfere with the outer petals.

TABLE 2
Print Settings
Print Settings (200 μm Tip)

| | | | | UV Cure | | Print |
|---|---|---|---|---|---|---|
| Temperatures | | Flowrates (SCCM) | | Intensity | Overlap | Speed |
| PA | 50° C. | Sheath | 60 | 50% (for two | 80%, 85%, 95% | 0.5 mm/s |
| Heat | | | | 1 W bulbs at | (outer, middle, | |
| Bubbler | 25° C. | Atomizer | 1025 | approx. 75 | inner rings, | |
| Heat | | | | mm separation | respectively) | |
| PA Stir | 0.1 V, | VI | 0.461 PSI | from sample) | | |
| | then | Exhaust | | | | |
| | 0 V | | | | | |
| Platen | 25° C. | VI | 1025 | | | |
| Heat | | Sheath | | | | |
| Chiller | 20° C. | Boost | 80 | | | |
| Temp | | Divert | 80 | | | |

### Example 7

Conductive inks were printed, as both traces and as squares, onto a dielectric ink (UV#303 shown in Table 1 above). Crosshatches were added to the squares by cutting with a razor tool. The conductive traces were printed with DuPont CB028 silver ink. A Nordson 100 μm precision metal tip was used to print the ink. The following print parameters were used: print speed: 1 mm/s; wait time (time the program waits with the valve open before it starts moving, which helps to build up the pressure in the tip for smoother printing): 0.5 s; print pressure: 1 psi. All conductive traces were cured on a hot plate at 160° C. for 10 minutes.

An ASTM adhesion tape test (ASTM D3359) was used to test the adhesion of the conductive ink onto the dielectric ink. The tests were performed on different substrates, including Kapton, metal, and glass. The number of passes of UV303 ink was also varied to observe whether it affected the adhesion of the silver to the UV303.

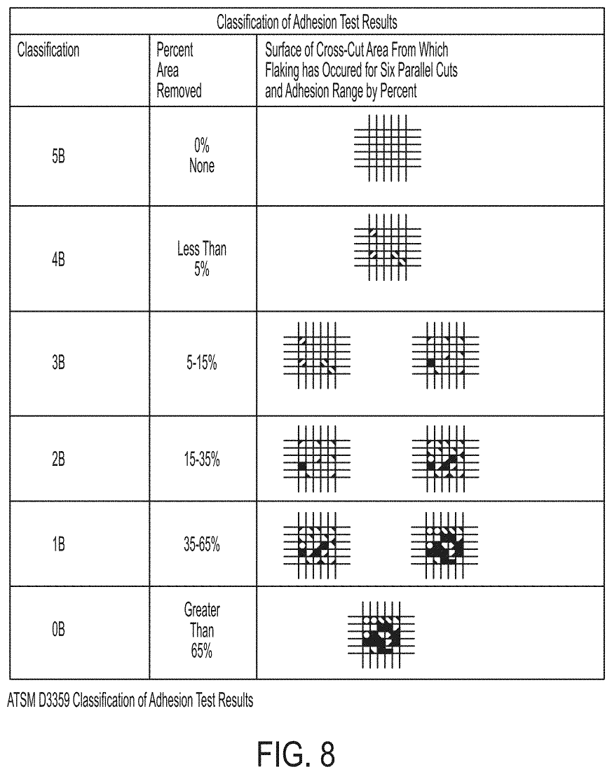

FIG. 8 shows how the results of the ASTM test are assessed and classified. The adhesion tape test begins by printing squares with ink (CB028 silver ink). A 6-tooth, 1 mm spaced blade is used to add the crosshatching into the cured ink. Once crosshatch is recorded (for comparison purposes), the polyester rope fiber laminate tape is applied to the square and is rubbed with a bristle brush to ensure that the tape is adhered to the crosshatch. The tape is then peeled off, and the parts of the crosshatch that remain on the substrate are evaluated with the classification chart, shown in FIG. 8. Once the test square is cut, prior to adhering the tape to the test area, a picture is taken. This will provide a comparison, so that once the tape is applied and lifted off the test area, there is a method of comparison between the two. The tape is added as described previously. The test area is recorded (picture) after the tape has been lifted off. The differences between these two images are compared, using FIG. 8. The more material that is lifted off with the tape, the worse the score that specific test area will receive (OB is the worst score, and 5B is the best score.)

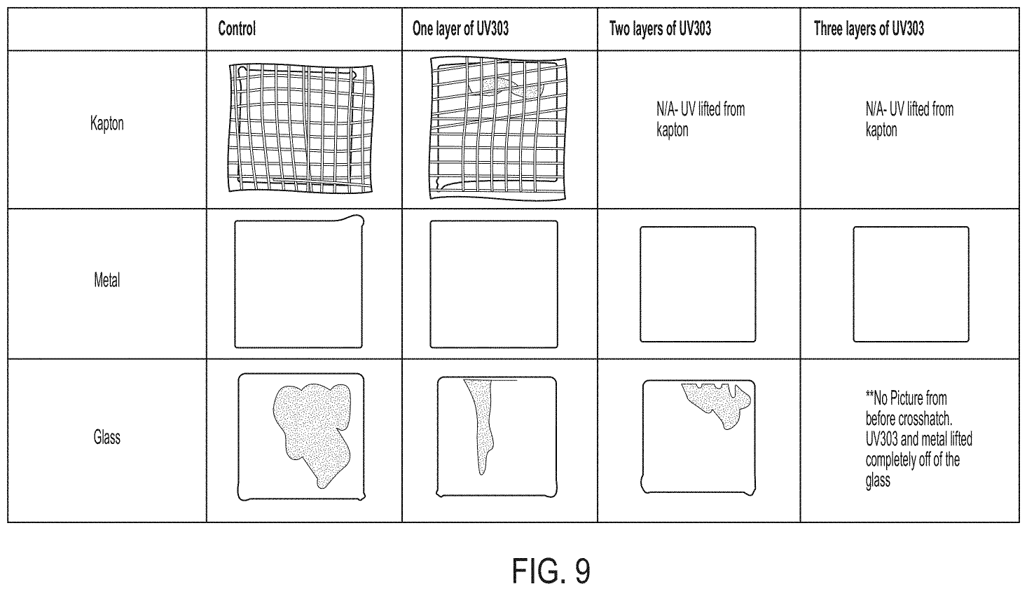

FIG. 9 shows the results of ASTM adhesion tape testing of CB028 prior to the adhesion tape test. One to three layers were assessed and compared to a control. The control for the adhesion tape test is a test square (CB028) printed directly onto a substrate (kapton, metal, glass). The adhesion tape test is performed on this control to show how the adhesion of the silver ink is changed with the addition of UV303 between the substrate (Kapton, metal, glass) and the printed square (CB028). The Kapton control and one layer of UV303 were were recorded before the tape test was done, but after the crosshatches were applied to the samples, which would not affect the results of the adhesion tape test.

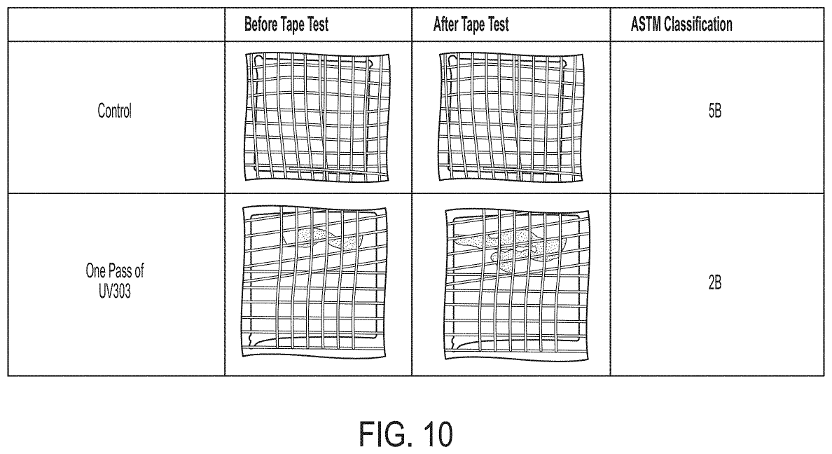

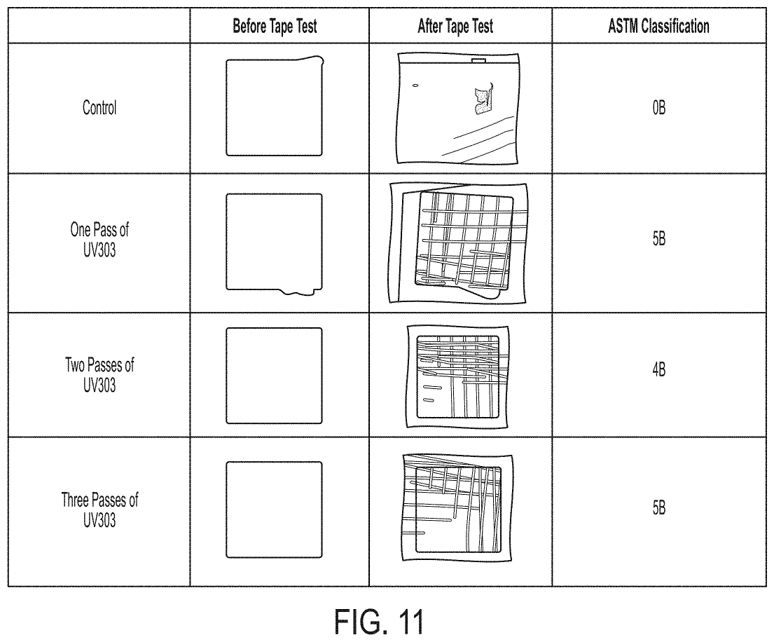

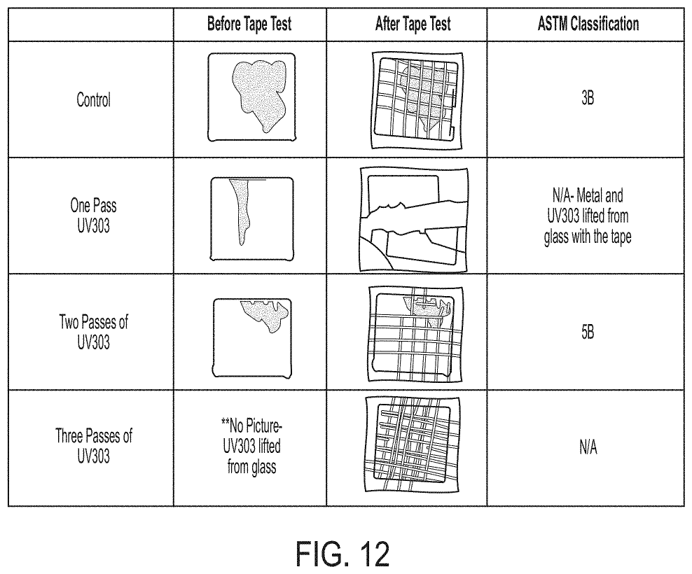

FIGS. 10-12 show the results of ASTM adhesion tape testing of CB028 after adhesion tape testing on Kapton, metal, and glass, respectively. One to three passes of UV303 was compared to a control.

The ASTM adhesion tape testing demonstrated that UV303 adheres better to the metal than it does to Kapton or glass, which may be due, without being bound by theory, to the surface roughness. CB028 showed improved adhesion to substrates when a layer of UV303 was printed between the substrate and the CB028.

### Example 8

The electrical characteristics of dielectric ink UV303 was analyzed. A control trace of silver was printed onto Kapton, and electrical measurements were performed. A multilayer structure that included UV303 and silver was formed, which was prepared by the following steps. (1) A layer (or multiple layers) of UV303 was printed and cured onto a separate Kapton substrate. (2) A silver trace was printed on the UV303 and cured, and electrical measurements were performed. (3) A layer of UV303 was printed and cured on top of the silver trace; pads were left exposed in order to perform electrical measurements once the trace was buried. (4) A second metal trace was printed and cured on top of the second layer of UV303, which created a multilayer conductive print; electrical were measurements taken. The metal traces were printed orthogonal to one another to prevent the test leads from overlapping.

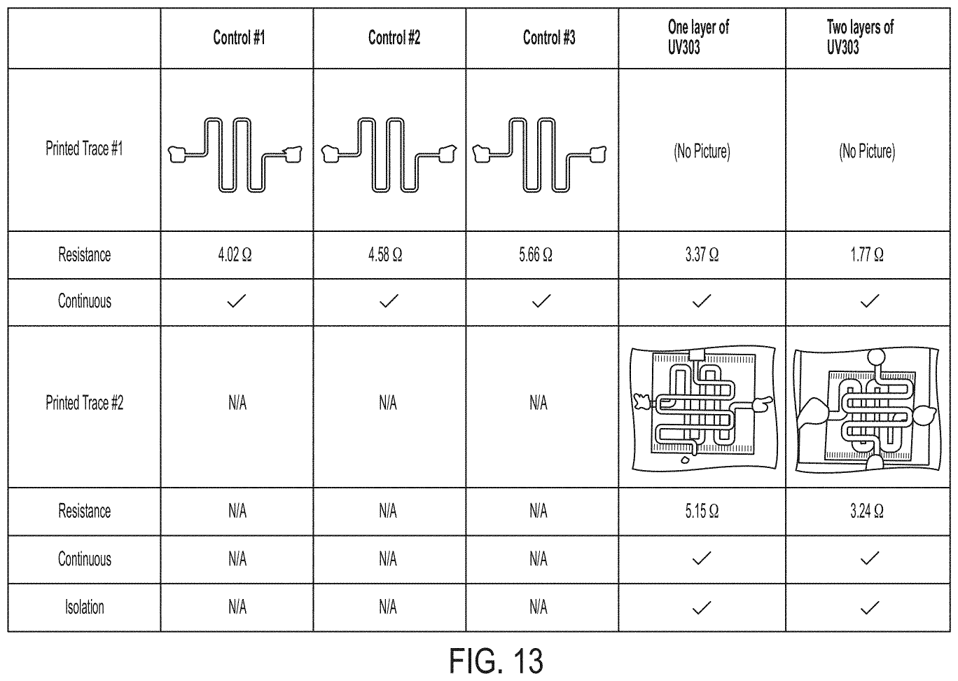

FIG. 13 shows the results of electrical characterization of the various combinations. When compared to the control, the first printed traces, printed on one and two layers of UV303, showed no degradation of the DC resistance. There was a trend in the data that showed the more passes of UV ink between the silver trace and the Kapton, the lower the resistance. For the second trace, second layer of UV, and the first traces, which were buried by the second trace of UV303 followed by the silver, the results showed that the UV303 was successfully able to isolate two printed traces on different layers, which means, electrically, they do not touch. This enables the creation of multilayer 2D circuit designs.

The foregoing example demonstrates that the UV curable ink can be deposited in layers as thin as 10-20 μm, and subsequent passes can provide layers of greater thickness as required. The examples also show that printed coils can be isolated by AJP layers of UV303 and that gaps between layers can be printed for additive vias between layers.

### Example 9

The trace profiles (thickness) of CB028 were measured uding a Bruker GTContour optical prolifometer. A silver trace directly on Kapton had an average height of 4.7933μ. Silver on one pass of UV303 had an average height of 4.9872 μm. Silver on two passes of UV303 had an average height of 4.0776 μm.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form detailed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the various embodiments with various modifications as are suited to the particular use contemplated.

While the preferred embodiments have been described, it will be understood that those skilled in the art, both now and in the future, may make various improvements and enhancements which fall within the scope of the claims which follow. These claims should be construed to maintain the proper protection for the disclosure as first described.

What is claimed is:

1. A dielectric ink composition comprising:
an epoxy precursor; and
a photoacid generator;
wherein the dielectric ink composition is aerosolable and ultraviolet (UV) curable.

2. The dielectric ink composition of claim 1, wherein the epoxy precursor is a monomeric ether, an oligomeric ether, or a polymeric ether.

3. The dielectric ink composition of claim 1, wherein the epoxy precursor is trimethylol propane triglycidal ether, tris(4-hydroxyphenyl)methane triglycidyl ether, poly(4,4′-isopropyledenediphenol-epichlorohydrin), 3,4 epoxycyclohexylmethyl-3′,4′-epoxycyclohexane carboxylate, a mixture of poly(4,4′-i sopropyledenediphenol-epichlorohydrin) and trimethylol propane triacrylate, or any combination thereof.

4. The dielectric ink composition of claim 1, wherein the epoxy precursor is an epichlorohydrin monomer, epichlorohydrin oligomer, or epichlorohydrin polymer.

5. The dielectric ink of claim 1, wherein the photoacid generator absorbs UV light in a wavelength range of about 190 to about 365 nanometers (nm).

6. The dielectric ink composition of claim 1, further comprising a photosensitizer, an organic dye, a surfactant, or a combination thereof.

7. The dielectric ink composition of claim 1, further comprising an epoxy monomer comprising a triphenyl methyl moiety that changes color when UV cured.

8. A method of printing a dielectric ink, the method comprising:
combining an epoxy precursor and a photoacid generator to form a pre-polymer composition;
atomizing the pre-polymer composition into an aerosol jet stream;
depositing the aerosol jet stream onto a substrate to form a layer of dielectric ink; and
curing the layer of dielectric ink using ultraviolet (UV) light.

9. The method of claim 8, wherein the epoxy precursor is a monomeric ether, an oligomeric ether, or a polymeric ether.

10. The method of claim 8, wherein the epoxy precursor is trimethylol propane triglycidal ether, tris(4-hydroxyphenyl)methane triglycidyl ether, poly(4,4′-isopropyledenediphenol-epichlorohydrin), 3,4 epoxycyclohexylmethyl-3′,4′-epoxycyclohexane carboxylate, a mixture of poly(4,4′-i sopropyledenediphenol-epichlorohydrin) and trimethylol propane triacrylate, or any combination thereof

11. The method of claim 7, wherein the epoxy precursor is an epichlorohydrin monomer, epichlorohydrin oligomer, or epichlorohydrin polymer.

12. The method of claim 7, wherein the photoacid generator absorbs UV light in a wavelength range of about 190 to about 365 nanometers (nm).

13. The method of claim 7, further comprising adding a photosensitizer, an organic dye, a surfactant, or a combination thereof, to the pre-polymer composition.

14. The method of claim 7, further comprising adding an epoxy monomer comprising a triphenyl methyl moiety that changes color when cured.

15. A method of making a dielectric ink, the method comprising:
combining an epoxy precursor with a photoacid generator to form an aerosolable pre-polymer composition;
curing the pre-polymer composition using ultraviolet (UV) light.

16. The method of claim 15, wherein the epoxy precursor is a monomeric ether, an oligomeric ether, or a polymeric ether.

17. The method of claim 15, wherein the epoxy precursor is trimethylol propane triglycidal ether, tris(4-hydroxyphenyl)methane triglycidyl ether, poly(4,4′-isopropyledenediphenol-epichlorohydrin), 3,4 epoxycyclohexylmethyl-3′,4′-epoxycyclohexane carboxylate, a mixture of poly(4,4′-i sopropyledenediphenol-epichlorohydrin) and trimethylol propane triacrylate, or any combination thereof.

18. The method of claim 15, wherein the epoxy precursor is an epichlorohydrin monomer, epichlorohydrin oligomer, or epichlorohydrin polymer.

19. The method of claim 15, wherein the photoacid generator absorbs UV light in a wavelength range of about 190 to about 365 nanometers (nm).

20. The method of claim 15, further comprising adding a photosensitizer, an organic dye, a surfactant, or a combination thereof, to the pre-polymer composition.
